(19) United States
(12) Patent Application Publication
(10) Pub. No.: US 2003/0154156 A1
(43) Pub. Date: Aug. 14, 2003

(54) System and method for managing inventory dynamically

(76) Inventors: Sundy Lee, Shenzhen (CN); Joe Zhou, Shenzhen (CN); Larry Zhang, Shenzhen (CN); Elecson Wu, Shenzhen (CN); Andong Li, Shenzhen (CN); Weiguo Ding, Shenzhen (CN); Denny Shu, Shenzhen (CN)

Correspondence Address: WEI TE CHUNG, FOXCONN INTERNATIONAL, INC., 1650 MEMOREX DRIVE, SANTA CLARA, CA, 95050, US

(21) Appl. No.: 10/158,378

(22) Filed: May 29, 2002

(30) Foreign Application Priority Data
Feb. 8, 2002 (TW) 91102464

(51) Int. Cl. G06F 17/60

(52) U.S. Cl. 705/37

(57) ABSTRACT

A system and method for managing inventory dynamically. The system includes personal computers (10), a central server (11), a central database (12), a web server (13), a carrier information system (14), and branch servers (15). The personal computers are located in various departments of a manufacturer and linked to the central server, for users to obtain and manage inventory information. The central database is linked to the central server for storing inventory information. The web server is linked to the central database, for relevant personnel of clients and carriers to obtain real-time inventory information. The carrier information system is linked to the central server, for transmitting information on in-transit inventory to the central server during transportation. The branch servers are located in overseas hubs/factories of the manufacturer and linked to the central server, for sending information on any changes in inventory in the hubs/factories to the central server.

### BACHGROUND OF THE INVENTION

1. Field of the Invention

The present invention relates to a system and method for managing inventory dynamically, and more particularly to a system and method for dynamically managing in-transit inventory via an electronic communications network.

2. Description of Related Art

With intense business competition, it is important for manufacturers to deliver their products to clients in time. Therefore a manufacturer has to properly control inventory of raw materials, semi-finished products and finished products stored in its warehouse, and properly control transportation of all inventory from the warehouse.

Generally, a large manufacturer may transport products to clients all over the world. To promptly meet orders of such clients, the manufacturer usually establishes distribution centers or factories that are located near the clients. The factories are normally built for further processing of semi-finished products prior to sale of the finished products. The manufacturer usually organizes production in one place, and transports finished products or semi-finished products to its distribution centers or factories for ultimate sale to the clients. The finished products or semi-finished products may be transported by land, sea, or air. To ensure prompt delivery to clients, responsible personnel of the manufacturer have to know the exact status of finished and semi-finished products that are in transit. Such personnel can then timely adjust production and marketing schedules according to the current prevailing status, and rapidly respond to unforeseen difficulties. Typically, a manufacturer relies on conventional communication means such as telephone, fax and telex to ascertain the exact status of finished and semi-finished products that are in transit. However, such means are relatively slow and cumbersome, and prone to human error and random mechanical error and breakdown.

Accordingly, what is needed is a system and method that quickly, conveniently and reliably provides responsible personnel of a manufacturer with real-time status of inventory in transit.

### SUMMARY OF THE INVENTION

It is a primary object of the present invention to provide a system and method for managing inventory dynamically, whereby responsible personnel of a manufacturer can instantly obtain in-transit inventory information.

It is another object of the present invention to provide a system and method for managing inventory dynamically, whereby responsible personnel of a manufacturer can obtain real-time inventory information on all applicable warehouses via a web server.

To achieve the above objects, the present invention provides a system and method for managing inventory dynamically. A preferred embodiment of the system comprises a plurality of personal computers, a central server, a central database, a web server, a carrier information system, and a plurality of branch servers. The personal computers are located in various departments of a manufacturer and linked to the central server, for users to obtain and manage inventory information. The central database is linked to the central server for storing inventory information. The web server is linked to the central database, for relevant personnel of clients and carriers to obtain real-time inventory information. The carrier information system is linked to the central server, for transmitting information on in-transit inventory to the central server during transportation. The branch servers are located in overseas hubs/factories of the manufacturer and linked to the central server, for sending information on any changes in inventory in the hubs/factories to the central server.

The central server comprises a fundamental data module, an order module, a shipment module, a sales module, and an invoice module. The fundamental data module is for maintaining fundamental data stored in the central database. The order module is for managing orders, including adding, revising and finishing orders. The shipment module is for managing in-transit inventory. The sales module is for maintaining information on sold cargo. The invoice module is for maintaining invoices when selling cargo and receiving returned cargo.

A preferred embodiment of the method for managing inventory comprises the steps of: generating a shipment list and shipment notice, and sending the shipment notice to a carrier information system via a central server; updating status of cargo listed in the shipment notice after sending of the shipment notice, and storing updated status data in a central database; generating information on status of the cargo during transportation of the cargo, and sending the status information to the central server in real time via the carrier information system; generating a record when there is a change in inventory information at an overseas hub/factory, and sending the record to the central server via a branch server of the overseas hub/factory; and updating the inventory information in the central database via the central server according to the record.

### BRIEF DESCRIPTION OF THE DRAWINGS

FIG. 1 is a schematic illustration of hardware of a system for managing inventory dynamically in accordance with a preferred embodiment of the present invention;

FIG. 2 is a flow chart of movement of cargo according to the system shown in FIG. 1;

FIG.3 is a schematic illustration of modules of a central server shown in FIG. 1;

FIG. 4 illustrates a user interface displaying a transfer list generated by a shipment module shown in FIG. 3;

FIG. 5 illustrates a form for recording information on cargo stored in warehouses according to the system shown in FIG. 1;

FIG. 6 illustrates a form for recording information on products sold according to the system shown in FIG. 1;

FIG. 7 illustrates a daily inventory list of an overseas hub/factory according to the system shown in FIG. 1;

FIG. 8 is a schematic illustration of sub-modules of a web server shown in FIG. 1; and

FIG. 9 is a flow chart of main operating procedures performed according to the system shown in FIG. 1.

### DETAILED DESCRIPTION OF THE INVENTION

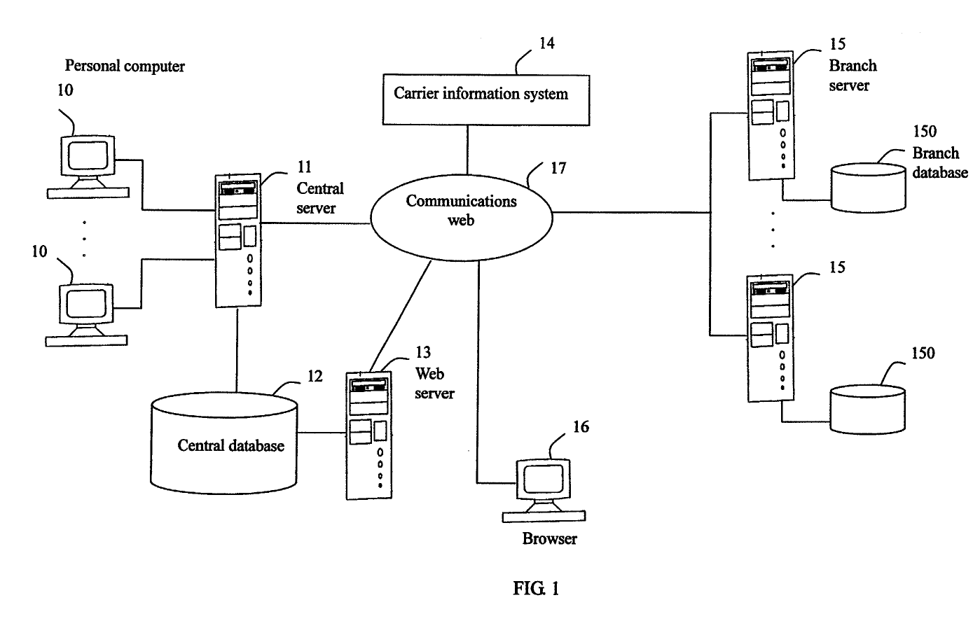

FIG. 1 is a schematic illustration of hardware of a system for managing inventory dynamically in accordance with a preferred embodiment of the present invention. The system comprises a plurality of personal computers 10, a central server 11, a central database 12, and a web server 13. The personal computers 10 are located in various departments of a manufacturing organization (“manufacturer”) for use by pertinent personnel including supervisors. Such departments may include a logistics department, and a finance and accounting department. In the preferred embodiment, the personal computers 10 are linked to the central server 11 and the web server 13 via an intranet. The central server 11 is linked to the central database 12 via the intranet, for storing inventory information in the central database 12 and for obtaining inventory information from the central database 12. Therefore the pertinent personnel can control the central server 11 via the personal computers 10.

Terms employed in this description of the present invention are explained in detail as follows.

“Cargo” may include component parts, semi-finished products, and/or finished products.

“Carrier” is a specialized contractor for transportation of cargo.

“Container” may include a standard 40-foot shipping container or standard 20-foot shipping container.

“Hub” is a distribution center.

“In-transit inventory” means cargo that has left a manufacturing site and has not yet been delivered to a client.

“Inventory” may include component parts, semi-finished products, and/or finished products.

“Product” may include a semi-finished product, or a finished product.

“Transfer” means changing the status or location of inventory from one status or location to another status or location.

“Warehouse” is a status or location of inventory, and includes both physical and virtual storage. In the preferred embodiment, the warehouses include an internal warehouse storing the inventory before the inventory is shipped out from the manufacturing site, an inland warehouse denoting the inventory has left the manufacturing site but has not yet been loaded on board a ship or vehicle for transportation, an on-the-way warehouse denoting the inventory is loaded on board a ship for transportation, a yard warehouse at a destination port for storing the inventory, an overseas hub being an overseas premises for distribution of inventory, an overseas factory being an overseas manufacturing facility that further processes semi-finished products, a reprocessing warehouse being premises in which inventory is reworked, and a scrap warehouse for storing scrapped inventory. The physical storage warehouses are the yard warehouse, overseas hub, overseas factory, reprocessing warehouse and scrap warehouse. The virtual storage warehouses are the inland warehouse and the on-the-way warehouse.

The web server 13 is also linked to the central database 12 via the intranet, for users to obtain relevant inventory information. In the preferred embodiment, users can visit the website of the central server 11 in the world wide web via a browser such as Microsoft Internet Explorer or Netscape Navigator, and obtain desired information via the web server 13. In the preferred embodiment, such users may be the pertinent personnel of the manufacturer itself, or relevant personnel of clients of the manufacturer and of carriers.

The system of the present invention also comprises a carrier information system 14 linked to the central server 11, for transmitting a status of in-transit inventory to the central server 11. In the preferred embodiment, the status of the in-transit inventory may be transmitted by fax, e-mail, File Transfer Protocol (FTP) or other suitable means.

The system of the present invention further comprises a plurality of branch servers 15, and at least one browser 16. In the preferred embodiment, the branch servers 15 are located at overseas hubs/factories. Each branch server 15 is linked to a respective branch database 150 that is used for storing information on receipt, stocking and shipment of inventory at the relevant hub/factory. Each branch server 15 comprises a report sub-module for generating various kinds of reports according to the information stored in the branch database 150. Such reports may include a daily inventory list and a shipment list. Each branch server 15 is also linked to a personal computer (not shown in FIG. 1) for pertinent personnel of the hub/factory to maintain data in the branch database 150. Each branch server 15 is linked to the central server 11 via a communications web 17, for instantly transmitting any changes in the branch database 150 to the central database 12. Each browser 16 is located at a client of the manufacturer, and is linked to the central server 11 via the communications web 17 for the client to obtain in-transit status of particular inventory.

In the preferred embodiment, the communications web 17 is the Internet. The communications web 17 can also be another kind of electronic communications network such as electronic data exchange (EDI), an intranet, or a Public Switched Telephone Network (PSTN).

In the preferred embodiment, each warehouse and each of a plurality of locations inside each warehouse is encoded with a special ID. The ID contains information such as type of warehouse, client, and applicable overseas hub/factory.

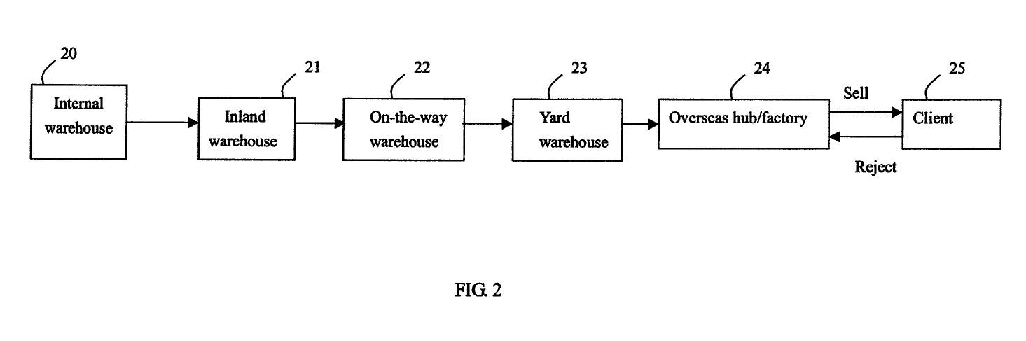

FIG. 2 is a flow chart of movement of cargo according to the system shown in FIG. 1. In FIG. 2, only warehouses such as an internal warehouse 20, an inland warehouse 21, an on-the-way warehouse 22, a yard warehouse 23 and an overseas hub/factory 24 are shown. Typically, the manufacturer consigns cargo to a carrier for transportation. The carrier can transport the cargo by land, sea, or air. In this description of the preferred embodiment, sea transportation is used as an example. After leaving the internal warehouse 20, the cargo is transported to the yard warehouse 23 via the inland warehouse 21 and the on-the-way warehouse 22. Subsequently, the cargo is either transported to the overseas hub 24 and sold to a client 25, or transported to the overseas factory 24. After being processed in the overseas factory 24, the cargo is sold to a client 25. However, the fact that the cargo is sold and delivered to a client 25 does not necessarily mean that the physical flow of the cargo is ended. The client 25 may return the cargo for some reason. Typically, returned cargo is sent to a reprocessing warehouse or a scrap warehouse. The reprocessing and scrap warehouses are often located in or near the overseas hub/factory 24.

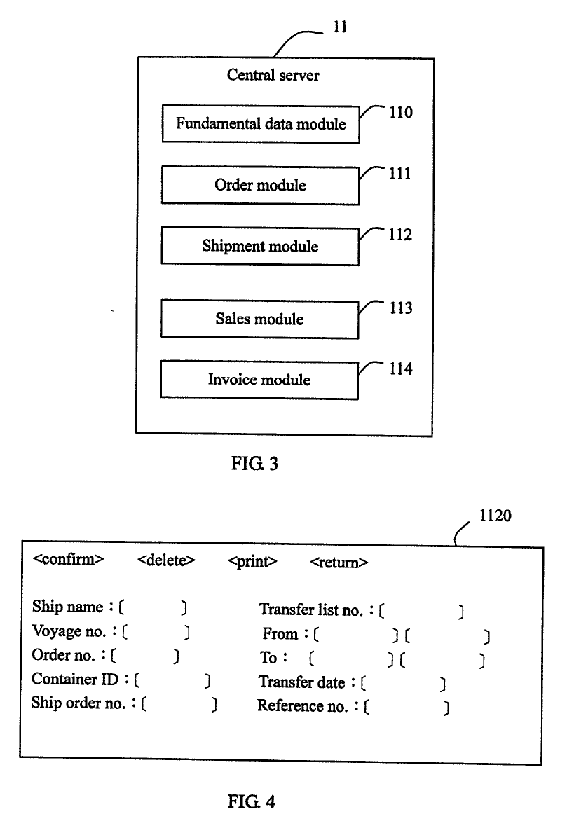

FIG. 3 is a schematic illustration of modules of the central server 11 shown in FIG. 1. The central server 11 comprises a fundamental data module 110, an order module 111, a shipment module 112, a sales module 113, and an invoice module 114. The fundamental data module 110 is used for maintaining fundamental data stored in the central database 12, including defining, establishing, adding, revising and deleting fundamental data. The fundamental data contains information on cargo, containers, carriers, warehouses, and clients. The order module 111 is used for managing orders including adding, revising and finishing orders. The shipment module 112 is used for managing transportation of the cargo once the cargo leaves the manufacturing site, including preparing and maintaining a shipment list, maintaining a packaging list, and preparing a transfer list. The sales module 113 is used for maintaining information on sold cargo. The invoice module 114 is used for maintaining invoices when selling cargo and receiving returned cargo.

In the system of the present invention, the central server 11 instantly updates status of cargo and other information according to the transfer of cargo. There are two ways to update. The first way is to update by cargo, and the second way is to update by container. In this description of the preferred embodiment, the second way is used as an example. After the container is loaded on board a ship, the carrier sends this information to the manufacturer. Then the shipment module 112 in the central server 11 changes the status of the container from the inland warehouse 21 to the on-the-way warehouse 22, and generates a transfer list 1120. The transfer list 1120 contains all information about this transfer, and is described in detail in relation to FIG. 4.

FIG. 4 illustrates a user interface displaying a transfer list 1120 generated by the shipment module 112 shown in FIG. 3. The transfer list 1120 includes ship name, voyage no., origin (“From”) and destination (“To”), container ID, transfer list no., transfer date, ship order no., and reference no. The origin shows an ID of the previous warehouse. The destination shows an ID of the final destination. At a top of the interface, there are four function buttons: confirm, delete, print, and return. Users can click on these buttons to confirm, delete, or print the transfer list 1120.

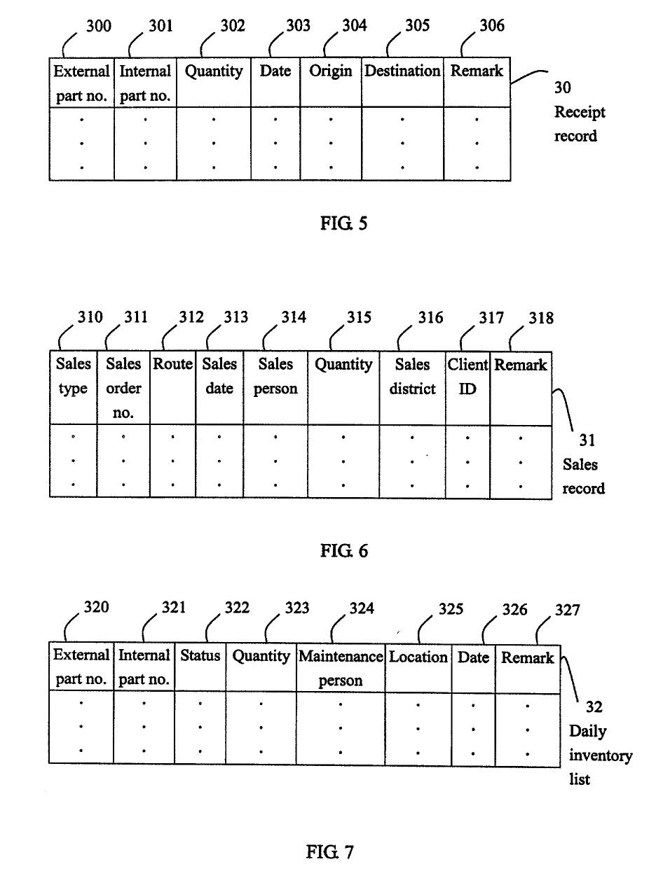

FIG. 5 illustrates a form, herein referred to as a receipt record 30, for recording information on cargo stored in each warehouse according to the system of the present invention. The carrier information system 14 or the branch server 15 of the overseas hub/factory 24 generates a receipt record 30 when the carrier or the overseas hub/factory 24 receives cargo. The receipt record 30 includes external part no. 300, internal part no. 301, quantity 302, date 303, origin 304, destination 305, and remark 306. The internal part no. 301 is a code for the cargo designated by the manufacturer. The external part no. 300 is the corresponding code of the same cargo designated by the client. The quantity 302 is the amount of the cargo stored in the corresponding warehouse. The date 303 displays the date when the cargo is first stored in the warehouse. The origin 304 shows an ID of the previous warehouse. The destination 305 shows an ID of the final destination. The remark 306 is used for recording other information on the cargo.

FIG. 6 illustrates a form, herein referred to as a sales record 31, for recording information on each product sold by the overseas hub/factory 24. The branch server 15 of the overseas hub/factory 24 generates a sales record 31 when the overseas hub/factory 24 sells a product. The sales record 31 includes sales type 310, sales order no. 311, route 312, sales date 313, sales person 314, quantity 315, sales district 316, client ID 317, and remark 318. The sales type 310 may be an entry such as “direct sale,” or “sale after reprocessing.” The route 312 is the path that the sold product travels along from the overseas hub/factory 24 to the client. The sales person 314 is the person in charge of the sale.

FIG. 7 illustrates a daily inventory list of the overseas hub/factory 24. The daily inventory list 32 is generated by the branch server 15 of the overseas hub/factory 24 at regular intervals, and displays daily inventory information. The daily inventory list 32 includes external part no. 320, internal part no. 321, status 322, quantity 323, maintenance person 324, location 325, date 326, and remark 327. The status 322 may be an entry such as “in the overseas hub,” “in the reprocessing warehouse,” or “in the scrap warehouse.” The quantity 323 is the amount of every kind of inventory in stock. The maintenance person 324 is the person in charge of maintaining the daily inventory list 32. The location 325 is the ID of the location of the inventory in the applicable warehouse. The date 326 is the date when the daily inventory list 32 is prepared.

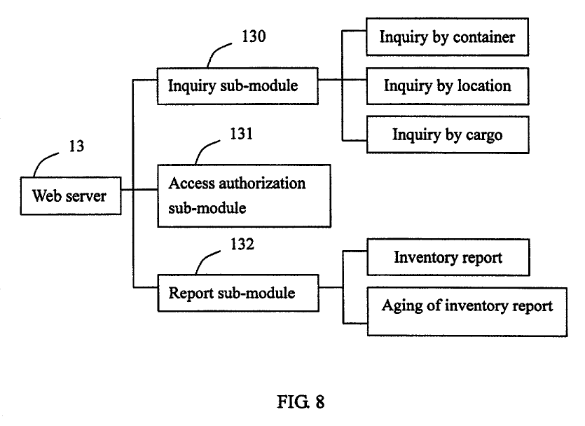

FIG. 8 is a schematic illustration of sub-modules of the web server 13 shown in FIG. 1. The web server 13 comprises an inquiry sub-module 130, an access authorization sub-module 131, and a report sub-module 132. The inquiry sub-module 130 provides three kinds of inquiry: inquiry by container, inquiry by location, and inquiry by cargo. The report sub-module 132 can output the outcome of any enquiry. In addition, the report sub-module 132 can generate a report on aging of inventory. The report on aging of inventory provides historical information on periods that the cargo has been respectively stored in various warehouses. The access authorization sub-module 131 is used for authorizing users to have various rights to access the central database 12, and for confirming users' identifications. For example, a client of the manufacturer can only obtain, and if necessary revise, information on cargo ordered by that client. Such client cannot obtain or revise information on other cargo ordered by other clients.

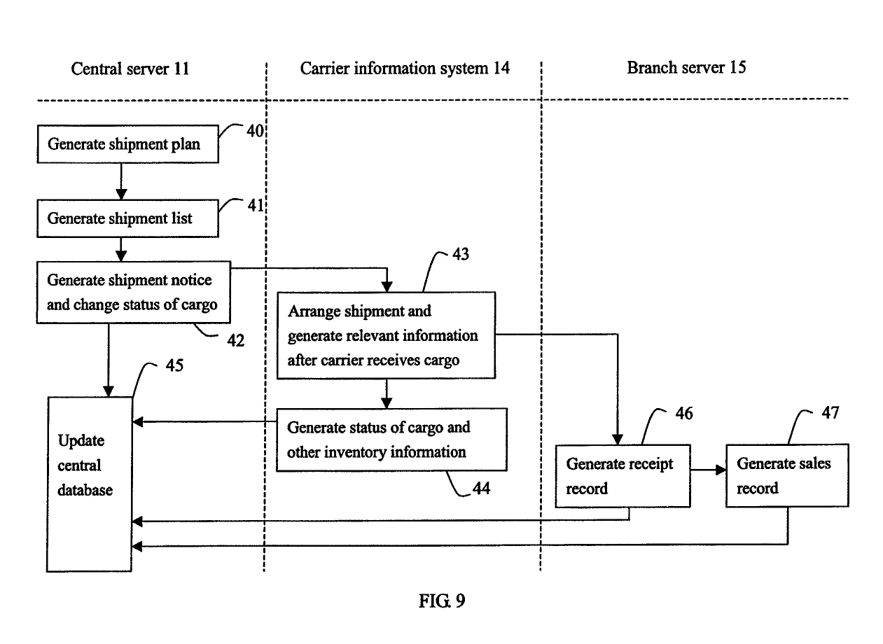

FIG. 9 is a flow chart of main operating procedures performed according to the system of the present invention. In step 40, the central server 11 generates a shipment plan according to delivery deadlines and production schedules. In step 41, the shipment module 112 of the central server 11 generates a shipment list according to the shipment plan. In step 42, the shipment module 112 generates a shipment notice, and sends the shipment notice to the carrier information system 14. The central server 11 then immediately changes a status of the cargo listed in the shipment notice, and in step 45 updates data in the central database 12 accordingly. In step 43, the carrier information system 14 arranges shipment by a carrier according to the shipment notice. Then after the carrier receives the cargo, the carrier information system 14 generates relevant information on the received cargo. In step 44, during transportation of the cargo by the carrier, the carrier information system 14 generates a status of the cargo such as “in the inland warehouse,” “in the on-the-way warehouse,” “in the yard warehouse” and other inventory information, and sends the status and other inventory information to the central server 11 in real time. In step 45, the shipment module 112 of the central server 11 updates the status and other inventory information in the central database 12 accordingly. In step 46, when the overseas hub/factory 24 receives the cargo sent by the carrier, the branch server 15 in the overseas hub/factory 24 generates a receipt record 30 and sends the receipt record 30 to the central server 11. In step 45, the central server 11 updates the inventory information in the central database 12 according to the receipt record. In step 47, when the overseas hub/factory 24 sells the cargo to a client, the branch server 15 in the overseas hub/factory 24 generates a sales record 31 and sends the sales record 31 to the central server 11. In step 45, the central server 11 updates the inventory information in the central database 12 accordingly.

In addition, when each daily inventory list 32 is generated by the branch server 15 of the overseas hub/factory 24, it is sent to the central server 11 in real time. The central server 11 updates the information in the central database 12 accordingly.

The above-described preferred embodiment of the present invention is to be construed as being illustrative of the present invention and not restrictive. Modification of the preferred embodiment within the spirit of the invention will be apparent to those skilled in the art, and any such modification is included in the scope of the invention as defined by the following claims.

What is claimed is:

1. A system for managing inventory dynamically, the system comprising:
a plurality of personal computers located in various departments of an organization;
a central server linked to the personal computers for users to access and manage inventory information;
a central database linked to the central server for storing inventory information;
a web server linked to the central database for users to access the inventory information; and
a plurality of branch servers located in various distribution centers and linked to the central server for sending information on changes in inventory in the distribution centers to the central server.

2. The system of claim 1, further comprising a carrier information system for sending information on in-transit inventory to the central server in real time.

3. The system of claim 2, wherein the information on the in-transit inventory includes current status of the in-transit inventory.

4. The system of claim 1, further comprising at least one browser linked to the web server for at least one client of the manufacturer to access the central database to obtain information on inventory.

5. The system of claim 1, wherein the central server includes a fundamental data module, a shipment module, a sales module, an order module, and an invoice module.

6. The system of claim 1, wherein the information on changes in inventory sent by the branch servers includes receipt records, sales records, and daily inventory lists of the distribution centers.

7. The system of claim 6, wherein the web server includes an inquiry sub-module, an access authorization sub-module, and a report sub-module.

8. A method for managing inventory, the method comprising the steps of:
generating a shipment list and shipment notice and sending the shipment notice to a carrier information system via a central server;
updating status of cargo listed in the shipment notice after sending of the shipment notice, and storing updated status data in a central database;
generating information on status of the cargo during transportation of the cargo, and sending the status information to the central server in real time via the carrier information system;
generating a record when there is a change in inventory information at an inventory receipt center, and sending the record to the central server via a branch server of the inventory receipt center; and
updating the inventory information in the central database via the central server according to the record.

9. The method of claim 8, further including the step of storing fundamental data in the central database via the central server.

10. The method of claim 8, further including the step of inquiring of inventory information at a personal computer via the central server.

11. The method of claim 8, further including the step of inquiring of inventory information at a personal computer via a web server.

12. The method of claim 8, further including the step of generating a daily inventory list via the branch server.

13. A central server assembly for use with a carrier information system, comprises a central server located in a manufacturer including a fundamental data module for maintaining fundamental data stored in the central database, an order module for managing orders, a shipment module for managing in-transit inventory, a sales module for maintaining information on sold cargo, and an invoice module for maintaining invoices when selling cargo and receiving returned cargo, wherein a plurality of branch servers are located in overseas hubs/factories and linked to said central server for sending information on any changes in inventory thereof to the central server.
